(19) United States
(12) Patent Application Publication
(10) Pub. No.: US 2026/0031276 A1
(43) Pub. Date: Jan. 29, 2026

(54) MULTILAYERED CERAMIC ELECTRONIC COMPONENT

(71) Applicant: NGK INSULATORS, LTD., Nagoya-shi (JP)

(72) Inventors: Isamu OGUMA, Tokyo (JP); Tomohiko HIBINO, Inazawa-shi (JP); Takaki FUJII, Tsuru-shi (JP)

(21) Appl. No.: 19/341,569

(22) Filed: Sep. 26, 2025

Related U.S. Application Data
(63) Continuation of application No. PCT/JP2024/006012, filed on Feb. 20, 2024.

(30) Foreign Application Priority Data
Mar. 30, 2023 (JP) 2023-055084

(51) Int. Cl. H01G 4/12; H01G 4/248; H01G 4/30

(52) U.S. Cl. CPC H01G 4/12; H01G 4/248; H01G 4/30

(57) ABSTRACT

A ceramic portion has a first surface and a second surface opposed to each other in a thickness direction. A first electrode includes a first portion disposed on the first surface. A second electrode includes a second portion disposed on the second surface. Each of the first surface and the second surface of the ceramic portion includes: a width dimension in a width direction; a length dimension in a length direction, the length dimension being larger than the width dimension and smaller than or equal to 1 mm; and a surface profile along the length direction, the surface profile including warpage of 2 μm or more in the thickness direction.

### CROSS-REFERENCE TO RELATED APPLICATION

This application is a continuation application of PCT/JP2024/006012, filed on Feb. 20, 2024, which claims the benefit of priority of Japanese Patent Application No. 2023-055084, filed on Mar. 30, 2023, the entire contents of which are incorporated herein by reference.

### BACKGROUND

### Technical Field

The present invention relates to a multilayered ceramic electronic component.

### Description of the Background Art

Japanese Patent Application Laid-Open No. 2006-005105 discloses a multilayered electronic component intended for suppressing deformation of a layered product. In this multilayered electronic component, at least one of holes or notches are formed in a second internal electrode at positions closer to a second end face with respect to the midpoint between a first end face and the second end face when viewed from a direction orthogonal to a laminating direction. This reduces a difference between the amount of each internal electrode included in a portion which is located at the midpoint between the first end face and the second end face of the layered product and which is closer to the first end face with respect to the central surface of the layered product parallel to each of the end faces, and the amount of each internal electrode included in a portion closer to the second end face with respect to the central surface of the layered product.

Japanese Patent Application Laid-Open No. 2019-009414 discloses a multilayer piezoelectric element including a multilayer piezoelectric body and a plurality of internal electrodes. This multilayer piezoelectric body includes: a pair of main surfaces facing a first-axis direction; a pair of end faces facing a second-axis direction which is orthogonal to the first-axis direction and is a length direction; and a pair of side faces facing a third-axis direction orthogonal to the first-axis direction and the second-axis direction. The plurality of internal electrodes are disposed inside the multilayer piezoelectric body, and are laminated in the first-axis direction. In the plurality of internal electrodes, a first cross section of a central internal electrode disposed in the center portion of the multilayer piezoelectric body when viewed from the third-axis direction has a larger undulation than that of a second cross section of the central internal electrode when viewed from the second-axis direction.

### SUMMARY

The multilayer piezoelectric element (a ceramic piezoelectric component) of Japanese Patent Application Laid-Open No. 2019-009414 is intended for improving displacement performance along the length direction. Considering widely multilayered ceramic electronic components without being limited to ceramic piezoelectric components, improvement in electrical characteristics has been often sought under constraints in the upper limit of the size of the multilayered ceramic electronic components. The improvement in electrical characteristics is, for example, improvement in capacitance.

Under the technology of the multilayer piezoelectric element (a multilayered ceramic electronic component) of Japanese Patent Application Laid-Open No. 2019-009414, it is conceivable that a large variation in the thickness of the piezoelectric body (a ceramic portion) that separates the internal electrode from other electrodes may occur due to the large undulations given to the internal electrode. Such large variations in thickness of the ceramic portion that separates the electrodes can conceivably have a non-negligible detrimental effect on the insulation reliability.

The present invention has been conceived to solve the problem, and has an object of providing a multilayered ceramic electronic component with enhanced electrical characteristics without a significant detrimental effect on the insulation reliability under constraints in the upper limit of the size.

Aspect 1 is a multilayered ceramic electronic component having a thickness direction, a width direction vertical to the thickness direction, and a length direction vertical to the thickness direction and the width direction, the multilayered ceramic electronic component including: a ceramic portion having a first surface and a second surface opposed to each other in the thickness direction; a first electrode including a first portion disposed on the first surface; and a second electrode including a second portion disposed on the second surface, wherein each of the first surface and the second surface of the ceramic portion includes: a width dimension in the width direction; a length dimension in the length direction, the length dimension being larger than the width dimension and smaller than or equal to 1 mm; and a surface profile along the length direction, the surface profile including warpage of 2 μm or more in the thickness direction.

Aspect 2 is the multilayered ceramic electronic component according to Aspect 1, wherein the ceramic portion has a third surface and a fourth surface opposed to each other in the length direction, the first electrode includes a third portion disposed on the third surface; and the second electrode includes a fourth portion disposed on the fourth surface.

Aspect 3 is the multilayered ceramic electronic component according to Aspect 2, wherein the first electrode includes a first internal electrode layer disposed in the ceramic portion and connected to the third portion.

Aspect 4 is the multilayered ceramic electronic component according to Aspect 3, wherein the second electrode includes a second internal electrode layer disposed in the ceramic portion and connected to the fourth portion.

Aspect 5 is the multilayered ceramic electronic component according to any one of Aspects 1 to 4, wherein the surface profile includes a plurality of extreme values.

Aspect 6 is the multilayered ceramic electronic component according to Aspect 5, wherein at least one of the first surface or the second surface includes a slit region sandwiched between a region covered with the first electrode and a region covered with the second electrode, and one of the plurality of extreme values of each of the first surface and the second surface exists in the slit region of the first surface or the second surface.

Aspect 7 is the multilayered ceramic electronic component according to Aspect 5 or 6, wherein the plurality of extreme values are two extreme values of a first extreme value and a second extreme value.

Aspect 8 is the multilayered ceramic electronic component according to Aspect 7, wherein the first extreme value and the second extreme value are located in the length direction at a first position and a second position, respectively, and a distance from a midpoint of the surface profile in the length direction to the second position is longer than a distance from the midpoint to the first position.

Aspect 9 is the multilayered ceramic electronic component according to Aspect 8, wherein an absolute value of the second extreme value is smaller than an absolute value of the first extreme value under leveling such that values of both ends of the surface profile are zero.

Aspect 10 is the multilayered ceramic electronic component according to any one of Aspects 7 to 9, wherein an absolute value of the second extreme value is 0.2 μm or more, and is less than half an absolute value of the first extreme value.

According to Aspects above, electrical characteristics can be enhanced without a significant detrimental effect on the insulation reliability under constraints in the upper limit of the size.

These and other objects, features, aspects, and advantages of the present invention will become more apparent from the following detailed description of the present invention when taken in conjunction with the accompanying drawings.

### BRIEF DESCRIPTION OF DRAWINGS

FIG. 1 is a top view schematically illustrating a structure of a multilayered ceramic electronic component according to Embodiment 1.

FIG. 2 is a schematic cross-sectional view along the line II-II in FIG. 1.

FIG. 3 is a diagram schematically illustrating a surface profile of a ceramic portion of the multilayered ceramic electronic component according to Embodiment 1.

FIG. 4 is a graph illustrating an example of measurement results of a surface profile corresponding to FIG. 3.

FIG. 5 is a partial cross-sectional view schematically illustrating a first step of a method of manufacturing the multilayered ceramic electronic component according to Embodiment 1.

FIG. 6 is a partial cross-sectional view schematically illustrating a second step of the method of manufacturing the multilayered ceramic electronic component according to Embodiment 1.

FIG. 7 is a diagram schematically illustrating a surface profile of a ceramic portion of a multilayered ceramic electronic component according to Embodiment 2.

FIG. 8 is a graph illustrating an example of measurement results of the surface profile corresponding to FIG. 7.

FIG. 9 is a cross-sectional view schematically illustrating a structure of a multilayered ceramic electronic component according to Embodiment 3 of the present invention.

FIG. 10 is a cross-sectional view schematically illustrating a structure of a multilayered ceramic electronic component according to Embodiment 4 of the present invention.

### DESCRIPTION OF THE PREFERRED EMBODIMENTS

Embodiments of the present invention will be described below based on the drawings. The same reference numerals are assigned to the same or equivalent portions in the drawings, and the description is not repeated. Furthermore, an XYZ rectangular coordinate system is shown in a part of the drawings to facilitate the understanding of directional relationships between the drawings.

### Embodiment 1

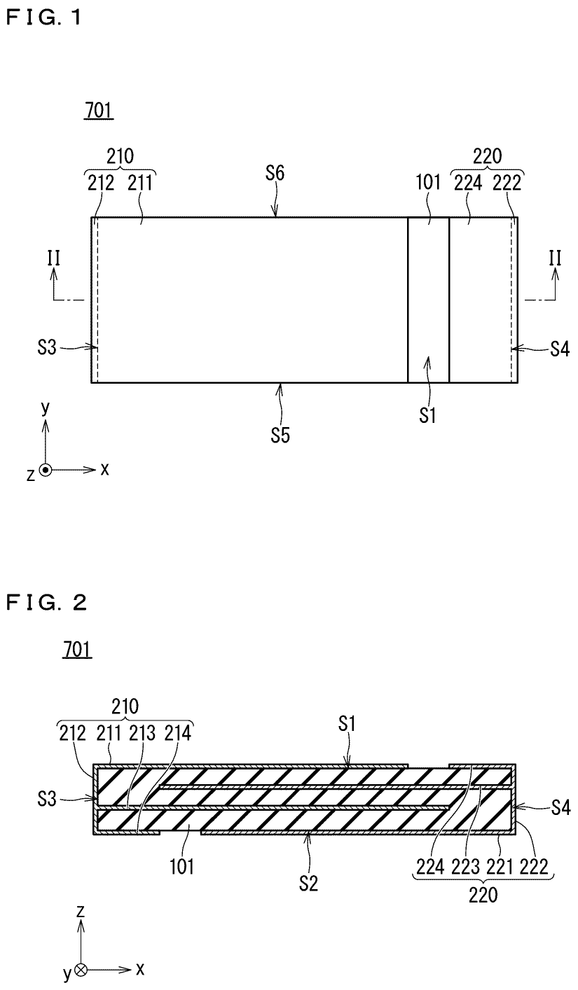

FIG. 1 is a top view schematically illustrating a structure of a multilayered ceramic electronic component 701 according to the present embodiment. FIG. 2 is a schematic cross-sectional view along the line II-II in FIG. 1. The multilayered ceramic electronic component 701 has a thickness direction (z direction), a width direction (y direction) vertical to the thickness direction, and a length direction (x direction) vertical to the thickness direction and the width direction. The multilayered ceramic electronic component 701 includes a ceramic portion 101, a first electrode 210, and a second electrode 220. The multilayered ceramic electronic component 701 may be a chip electronic component, for example, a chip capacitor.

The ceramic portion 101 may be made of an insulator. The ceramic portion 101 has the first surface S1 and the second surface S2 opposed to each other in the thickness direction. The first surface S1 and the second surface S2 are almost parallel to each other. Furthermore, the ceramic portion 101 may have a third surface S3 and a fourth surface S4 opposed to each other in the length direction. The third surface S3 and the fourth surface S4 may be almost parallel to each other. Furthermore, the ceramic portion 101 may have a fifth surface S5 and a sixth surface S6 opposed to each other in the width direction. The fifth surface S5 and the sixth surface S6 may be almost parallel to each other. The ceramic portion 101 has a length dimension (a dimension in x direction), a width dimension (a dimension in y direction), and a thickness dimension (a dimension in z direction). The length dimension is larger than the width dimension and the thickness dimension. The width dimension may be larger than the thickness dimension. The length dimension may be larger than or equal to 0.5 mm and smaller than or equal to 1 mm. The width dimension may be larger than or equal to 0.1 mm and smaller than or equal to 0.3 mm. The thickness dimension may be larger than or equal to 0.03 mm and smaller than or equal to 0.07 mm.

The first electrode 210 includes a portion 211 (a first portion) disposed on the first surface S1. Furthermore, the first electrode 210 may include a portion 212 (a third portion) disposed on the third surface S3. Furthermore, the first electrode 210 may include a portion 214 disposed on the second surface S2. Furthermore, the first electrode 210 may include a first internal electrode layer 213 disposed in the ceramic portion 101, and the first internal electrode layer 213 may be connected to the portion 212. The first electrode 210 is, for example, a platinum (Pt) electrode.

The second electrode 220 includes a portion 221 (a second portion) disposed on the second surface S2. Furthermore, the second electrode 220 may include a portion 222 (a fourth portion) disposed on the fourth surface S4. Furthermore, the second electrode 220 may include a portion 224 disposed on the first surface S1. Furthermore, the second electrode 220 may include a second internal electrode layer 223 disposed in the ceramic portion 101, and the second internal electrode layer 223 may be connected to the portion 222. The second electrode 220 is, for example, a platinum (Pt) electrode.

The second electrode 220 includes portions facing the first electrode 210 through the ceramic portion 101 in the thickness direction. This forms the capacitance between the first electrode 210 and the second electrode 220.

At least one of the first surface S1 or the second surface S2 may include a slit region sandwiched between a region covered with the first electrode 210 and a region covered with the second electrode 220. The slit region is not covered with any electrodes. In the present embodiment, each of the first surface S1 and the second surface S2 has a slit region as illustrated in FIG. 2.

Each of the first surface S1 and the second surface S2 of the ceramic portion has a width dimension in the width direction (y direction), a length dimension in the length direction (x direction), and a thickness dimension in the thickness direction (z direction). The length dimension is larger than each of the width dimension and the thickness dimension. The length dimension may be larger than or equal to 0.5 mm and smaller than or equal to 1 mm.

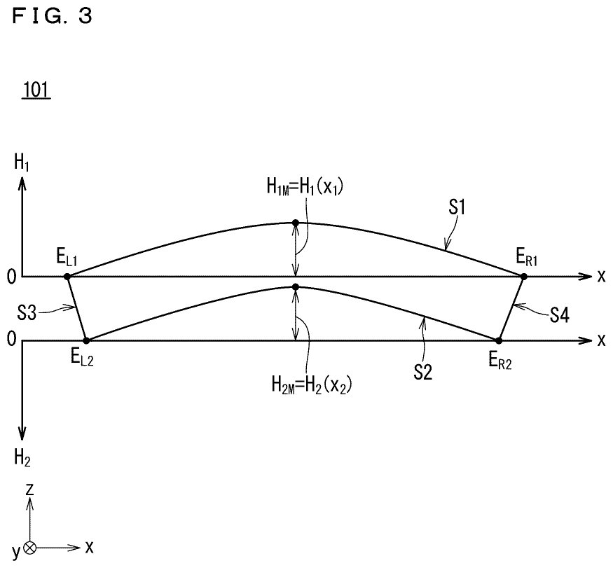

FIG. 3 is a diagram schematically illustrating a surface profile of each of the first surface S1 and the second surface S2 of the ceramic portion 101 of the multilayered ceramic electronic component 701 according to Embodiment 1 along the length direction (x direction). The first surface S1 has a surface profile H₁(x). The surface profile H₁(x) represents a surface height of the first surface S1 in z direction under leveling satisfying H₁(E_{L1})=H₁(E_{R1})=0 when both ends of the surface profile H₁(x) are represented by x=E_{L1} and x=E_{R1}. A positive height represents a protruding surface, and a negative height represents a recessed surface. x=E_{L1} and x=E_{R1} that are positions of both ends of the surface profile may be positions inward of the ends of the first surface S1 by approximately 50 μm for measurement reasons, in place of the positions of both ends of the first surface S1.

Similarly, the second surface S2 has a surface profile H₂(x). The surface profile H₂(x) represents a surface height of the second surface S2 in z direction under leveling satisfying H₂ (E_{L2})=H₂(E_{R2})=0 when both ends of the surface profile H₂(x) are represented by x=E_{L2} and x=E_{R2}. A positive height represents a protruding surface, and a negative height represents a recessed surface. x=E_{L2} and x=E_{R2} that are positions of both ends of the surface profile may be positions inward of the ends of the second surface S2 by approximately 50 μm for measurement reasons, in place of the positions of both ends of the second surface S2.

The surface profile H₁(x) of the first surface S1 has an extreme value HIM when x=x₁. The surface profile H₂(x) of the second surface S2 has an extreme value H_{2M} when x=x₂. The extreme value HIM is the local maximum value, and the extreme value H_{2M} is the local minimum value. As a modification, the extreme value HIM may be the local minimum value, and the extreme value H_{2M} is the local maximum value. In the present embodiment, each of the surface profile H₁(x) of the first surface S1 and the surface profile H₂(x) of the second surface S2 has only one extreme value.

An absolute value of the extreme value H_{1M} and an absolute value of the extreme value H_{2M} are almost the same value, and are, for example, values within 10% with respect to an average of these. The positions x₁ and x₂ are almost the same value, and are, for example, values within 10% with respect to an average of these. When the thickness of the ceramic portion 101 is almost uniform, the surface profile H₁(x) and the surface profile H₂(x) approximately correspond to functions that are mutually sign reversed. Each of the extreme value HIM and the extreme value H_{2M} is 2 μm or more. The extreme value HIM and the extreme value H_{2M} are regarded as warpage of the surface profile H₁(x) and the surface profile H₂(x), respectively. Thus, the magnitude of warpage is 2 μm or more. Furthermore, the magnitude of warpage may be 10 μm or less in terms of making the multilayered ceramic electronic component 701 favorable for surface mounting.

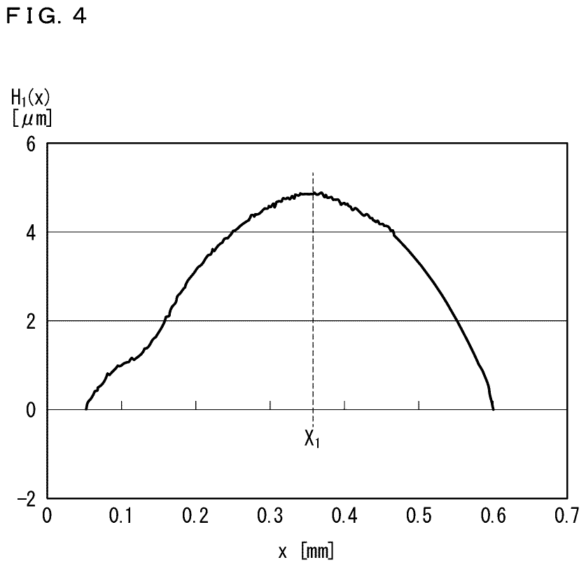

FIG. 4 is a graph illustrating an example of measurement results of the surface profile H₁(x) (see FIG. 3). An example of this measurement method will be described below. A method of measuring the surface profile H₂(x) (see FIG. 3) is identical to this.

First, a surface profile measurement of a surface corresponding to the first surface S1 (FIG. 2), specifically, a surface illustrated in FIG. 1 of the multilayered ceramic electronic component 701 is made by a laser scanner. The vicinity of the center in y direction is scanned along x direction as illustrated in the line II-II in FIG. 1. Since measurement variations in the scanned results at both ends in x direction are large due to various factors, data of approximately 50 μm in length at each of the ends may be deleted. The ends after this deletion correspond to x=E_{L1} and x=E_{R1} (FIG. 3). At this point in time, measurements are made to prepare height information at x positions of 500 points or more between x=E_{L1} and x=E_{R1}. Then, a smoothed surface profile is calculated using height information at 20 points ahead and behind.

Next, to remove the influence of a step formed between an electrode region (a region in which the first electrode 210 or the second electrode 220 is provided) and a non-electrode region (a region in which neither the first electrode 210 nor the second electrode 220 is provided) on the first surface S1, a surface profile of a section corresponding to the non-electrode region is replaced with a surface profile complemented by a polynomial approximation based on a section corresponding to the electrode region. Consequently, when the thicknesses of the first electrode 210 and the second electrode 220 on the first surface S1 can be regarded as almost uniform, the surface profile H₁(x) of the first surface S1 of the ceramic portion 101 can be obtained with sufficient accuracy. When the thicknesses of the first electrode 210 and the second electrode 220 on the first surface S1 cannot be regarded as uniform, correction based on results of cross-sectional photo observations may be performed. Furthermore, in view of evaluation objectives of the surface profile H₁(x), an obvious measurement error or variations in extremely local values may be ignored in the evaluation.

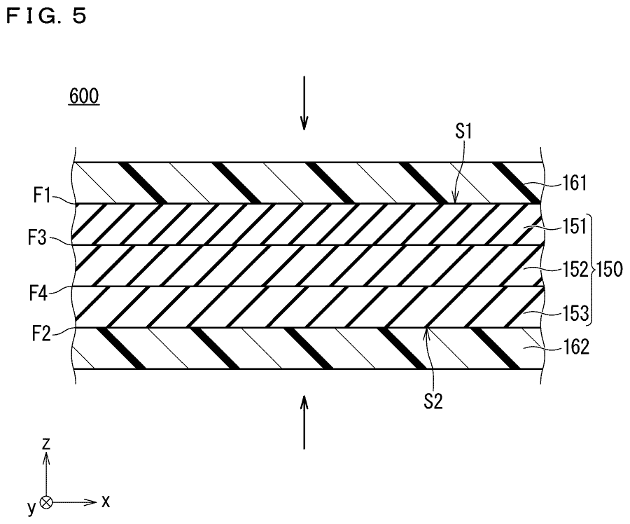

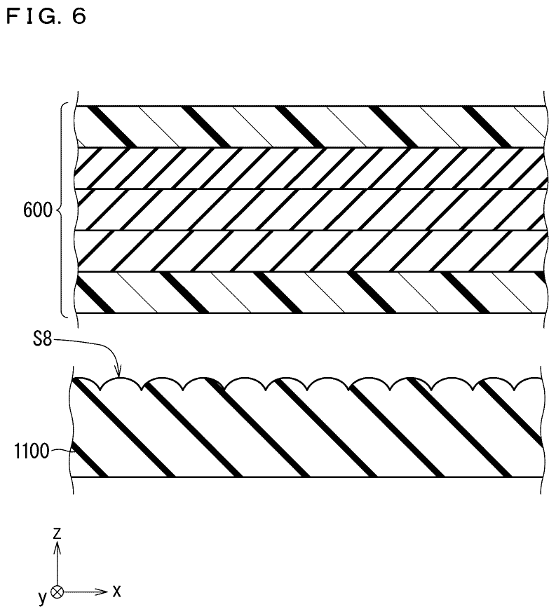

FIG. 5 and FIG. 6 are partial cross-sectional views schematically illustrating a first step and a second step, respectively, of a method of manufacturing the multilayered ceramic electronic component 701 (FIG. 2).

A work-in-progress 600 is formed with reference to FIG. 5. The work-in-progress 600 includes substrates 161 and 162, and a green laminate 150. The green laminate 150 is held between the substrates 161 and 162. Each of the substrates 161 and 162 is, for example, a polyethylene terephthalate (PET) film. The green laminate 150 includes green sheets 151 to 153 laminated in the thickness direction.

An interface F1 between the substrate 161 and the green sheet 151 corresponds to the first surface S1 of the multilayered ceramic electronic component 701 (FIG. 2) obtained from the green laminate 150. The substrate 161 may be a substrate to which slurry has been applied for molding the green sheet 151. Similarly, an interface F2 between the substrate 162 and the green sheet 153 corresponds to the second surface S2 of the multilayered ceramic electronic component 701 (FIG. 2) obtained from the green laminate 150. The substrate 162 may be a substrate to which slurry has been applied for molding the green sheet 153.

An electrode paste layer (not illustrated) to be the second internal electrode layer 223 (FIG. 2) through firing is formed at an interface F3 between the green sheets 151 and 152. An electrode paste layer (not illustrated) to be the first internal electrode layer 213 (FIG. 2) through firing is formed at an interface F4 between the green sheets 152 and 153. An electrode paste layer (not illustrated) to be the portion 211 of the first electrode 210 and the portion 224 of the second electrode 220 through firing may be formed at the interface F1. A part or the entirety of this electrode paste layer may be additionally applied after the substrate 161 is removed. An electrode paste layer (not illustrated) to be the portion 214 of the first electrode 210 and the portion 221 of the second electrode 220 through firing may be formed at the interface F2. A part or the entirety of this electrode paste layer may be additionally applied after the substrate 162 is removed.

The green sheets 151 to 153 adhere to each other as a result of a lamination pressing step as indicated by arrows in the drawing. In other words, the green sheets 151 to 153 make up the green laminate 150. The lamination pressing step may be performed by, for example, adding pressure indicated by the arrows in FIG. 5 to a pair of molds (not illustrated) that sandwich the work-in-progress 600. The lamination pressing step may be performed while heating. Examples of conditions of the lamination pressing step include a load of 100 kN, a temperature of 80 degrees, and a retention time of 60 seconds.

Next, an additional pressing step is performed with reference to FIG. 6. Specifically, the work-in-progress 600 is disposed between the pair of molds along the laminating direction (the vertical direction in the drawing). An elastic member 1100 is inserted between the work-in-progress 600 and one of the molds. Then, the work-in-progress 600 is pressed between the pair of molds.

The elastic member 1100 has a surface S8 facing the work-in-progress 600. The surface S8 may have a non-flat shape. This non-flat shape may correspond to the surface profile H₁(x). In typical mass production processes, many green bodies to be many ceramic electronic components 701 by firing are cut from one work-in-progress 600. In such a case, the surface S8 may be a wavy surface including many protruding shapes in a period corresponding to each of the extreme values HIM of many multilayered ceramic electronic components 701. The period of wavy shapes of the wavy surface in x direction is less than or equal to a length dimension (a dimension in x direction) of the ceramic portion 101 before firing. Furthermore, an amplitude of the wavy shapes is appropriately set according to the magnitude of warpage desirably given.

The elastic member 1100 is, for example, silicon rubber of 8 mm in thickness and with rubber hardness of 16. The rubber hardness may be a value measured by a durometer of JIS K 6249 of type A.

The additional pressing step may be performed while heating. Examples of conditions of the additional pressing step include a load of 100 kN, a temperature of 60 degrees, and a retention time of 60 seconds. As such, the temperature in the additional pressing step may be a temperature higher than room temperatures and lower than a temperature in the lamination pressing step. To adjust the magnitude of warpage, values of the load, the temperature, and the retention time may be, for example, increased or decreased from values described above in the conditions within a range of approximately 20%.

Furthermore, the additional pressing step may be repeated a plurality of times. In the additional pressing a plurality of times, relative positions of the work-in-progress 600 and the elastic member 1100 may be identical or different. In the latter method, a more complicated surface profile H₁(x) can be obtained without complicating the surface S8 of the elastic member 1100.

Next, green bodies to be ceramic electronic components 701 by firing are cut from the green laminate 150. In mass production processes, normally, many green bodies are cut from one green laminate 150. The multilayered ceramic electronic components 701 are obtained by firing the green bodies. As described above, the electrode paste layer may be additionally applied at appropriate timing. When this application is performed after the firing, additional firing is performed for the electrode paste layer.

According to Embodiment 1, the ceramic portion 101 (FIG. 3) has significant warpage. This increases effective lengths of the first electrode 210 and the second electrode 220 (FIG. 2). Thus, electrical characteristics, for example, capacitance can be enhanced without a significant detrimental effect on the insulation reliability under constraints in the upper limit of the size.

### Embodiment 2

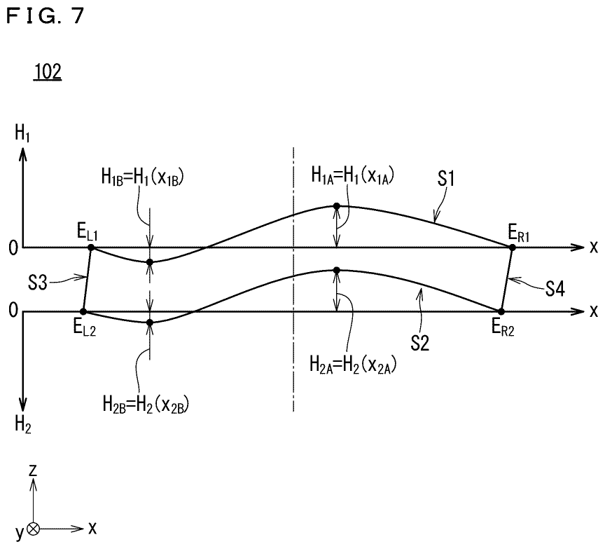

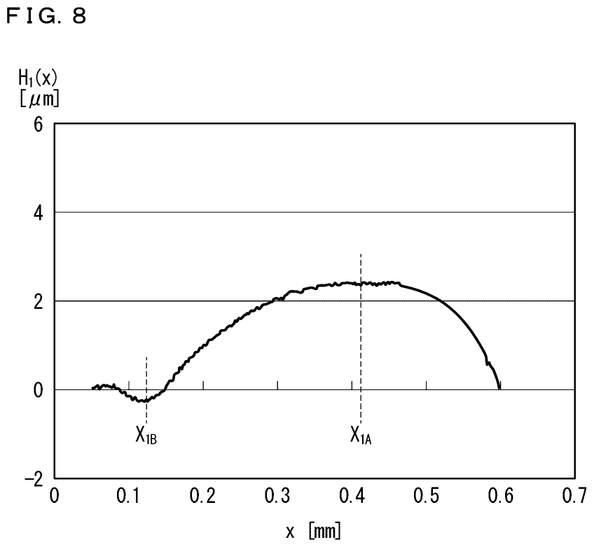

FIG. 7 is a diagram schematically illustrating a surface profile of each of the first surface S1 and the second surface S2 of a ceramic portion 102 according to the present embodiment along the length direction (x direction). FIG. 8 is a graph illustrating an example of measurement results of the surface profile of the first surface S1. In Embodiment 2, the ceramic portion 102 (FIG. 7) is used in place of the ceramic portion 101 (FIG. 3). Since the structure of the present embodiment except this is the same as the structure of the multilayered ceramic electronic component 701 (FIG. 2: Embodiment 1), the description will not be repeated. Since the definition and the measurement method of the surface profile are the same as those of FIG. 3 (Embodiment 1), the description will be omitted.

In the present embodiment, each of the surface profile H₁(x) of the first surface S1 and the surface profile H₂(x) of the second surface S2 includes a plurality of extreme values. Specifically, the surface profile H₁(x) has a first extreme value H_{1A}=H₁(x_{1A}) and a second extreme value H_{1B}=H₁ (x_{1B}). In other words, the first extreme value H_{1A} and the second extreme value H_{1B} are located in x direction at a position x_{1A} (a first position) and a position x_{1B} (a second position), respectively. Specifically, the surface profile H₂(x) has a first extreme value H_{2A}=H₂(x_{2A}) and a second extreme value H_{2B}=H₂(x_{2B}). In other words, the first extreme value H_{2A} and the second extreme value H_{2B} are located in x direction at a position x_{2A} (a first position) and a position x_{2B} (a second position), respectively.

At least one of the plurality of extreme values of each of the first surface S1 and the second surface S2 may exist in a slit region of the first surface S1 or the second surface S2. In other words, one of the positions of the plurality of extreme values of each of the first surface S1 and the second surface S2 may be included in a range of the slit region of the first surface S1 or the second surface S2 in x direction. For example, each of the position x_{1B} of the first surface S1 and the position x_{2B} of the second surface S2 may be included in the range of the slit region (a region sandwiched between the region covered with the first electrode 210 and the region covered with the second electrode 220 on the second surface S2 with reference to FIG. 2) of the second surface S2.

The first extreme value H_{1A} is a local maximum value, the first extreme value H_{2A} is a local minimum value, the second extreme value H_{1B} is a local minimum value, and the second extreme value H_{2B} is a local maximum value. An absolute value of the first extreme value H_{1A} and an absolute value of the first extreme value H_{2A} are almost the same value, and are, for example, values within 10% with respect to an average of these. Similarly, an absolute value of the second extreme value H_{1B} and an absolute value of the second extreme value H_{2B} are almost the same value, and are, for example, values within 10% with respect to an average of these. The positions x_{1A} and x_{2A} are almost the same value, and are, for example, values within 10% with respect to an average of these. Similarly, the positions x_{1B} and x_{2B} are almost the same value, and are, for example, values within 10% with respect to an average of these. When the thickness of the ceramic portion 102 is almost uniform, the surface profile H₁(x) and the surface profile H₂(x) approximately correspond to functions that are mutually sign reversed. As a modification, the first extreme value H_{1A} may be a local minimum value, the first extreme value H_{2A} may be a local maximum value, the second extreme value H_{1B} may be a local maximum value, and the second extreme value H_{2B} may be a local minimum value.

The first extreme value H_{1A} is an extreme value having the largest absolute value in the surface profile H₁(x), and the first extreme value H_{2A} is an extreme value having the largest absolute value in the surface profile H₂(x). Each of the absolute value of the first extreme value H_{1A} and the absolute value of the first extreme value H_{2A} is 2 μm or more. The absolute value of each of the extreme values except these is 0.2 μm or more. Thus, the absolute value of the second extreme value H_{1B} and the absolute value of the second extreme value H_{2B} is 0.2 μm or more. The absolute value of the first extreme value H_{1A} and the absolute value of the first extreme value H_{2A} may be 10 μm or less in terms of making the multilayered ceramic electronic component 702 favorable for surface mounting. The absolute value of the second extreme value H_{1B} may be less than or equal to half the absolute value of the first extreme value H_{1A} in the surface profile H₁(x), and the absolute value of the second extreme value H_{2B} may be less than or equal to half the absolute value of the first extreme value H_{2A} in the surface profile H₂(x). Each of the surface profile H₁(x) of the first surface S1 and the surface profile H₂(x) of the second surface S2 may have only two extreme values, that is, the first and second extreme values as illustrated in FIG. 7. When an additional extreme value is given as a modification, the absolute value of this additional extreme value is 0.2 μm or more which is less than the absolute value of the second extreme value. In other words, a value whose absolute value is less than 0.2 μm is not regarded as an extreme value.

A distance from a midpoint (a position in an alternate long and short dashed line in x direction in FIG. 7) of the surface profile H₁(x) in x direction to the position x_{1B} may be longer than a distance from this midpoint to the position x_{1A}. Similarly, a distance from a midpoint (a position in the alternate long and short dashed line in x direction in FIG. 7) of the surface profile H₂(x) in x direction to the position x_{2B} may be longer than a distance from this midpoint to the position x_{2A}.

According to Embodiment 2, the ceramic portion 102 (FIG. 7) includes the significant first and second extreme values. This increases effective lengths of the first electrode 210 and the second electrode 220 (FIG. 2). Thus, electrical characteristics, for example, capacitance can be enhanced without a significant detrimental effect on the insulation reliability under constraints in the upper limit of the size.

### Embodiment 3

FIG. 9 is a cross-sectional view schematically illustrating a structure of a multilayered ceramic electronic component 702 according to Embodiment 3. A ceramic portion 103 of the multilayered ceramic electronic component 702 may be identical to the ceramic portion 101 (FIG. 3) in Embodiment 1, the ceramic portion 102 (FIG. 7) in Embodiment 2, or one of the ceramic portions of these modifications.

The multilayered ceramic electronic component 702 includes a first electrode 230 and a second electrode 240 in place of the first electrode 210 and the second electrode 220 in the multilayered ceramic electronic component 701 (FIG. 2). The first electrode 230 is disposed on the first surface S1, and substantially on the entirety of the first surface S1 in the illustrated example. The first electrode 230 need not be disposed on a surface except the first surface S1. The second electrode 240 is disposed on the second surface S2, and substantially on the entirety of the second surface S2 in the illustrated example. The second electrode 240 need not be disposed on a surface except the second surface S2. In the present embodiment, the internal electrode layers 213 and 223 (FIG. 2) are not necessary.

Since the structure except the described structure is almost the same as that according to Embodiment 1 or 2, the same reference numerals are assigned to the same or corresponding elements and the description will not be repeated.

### Embodiment 4

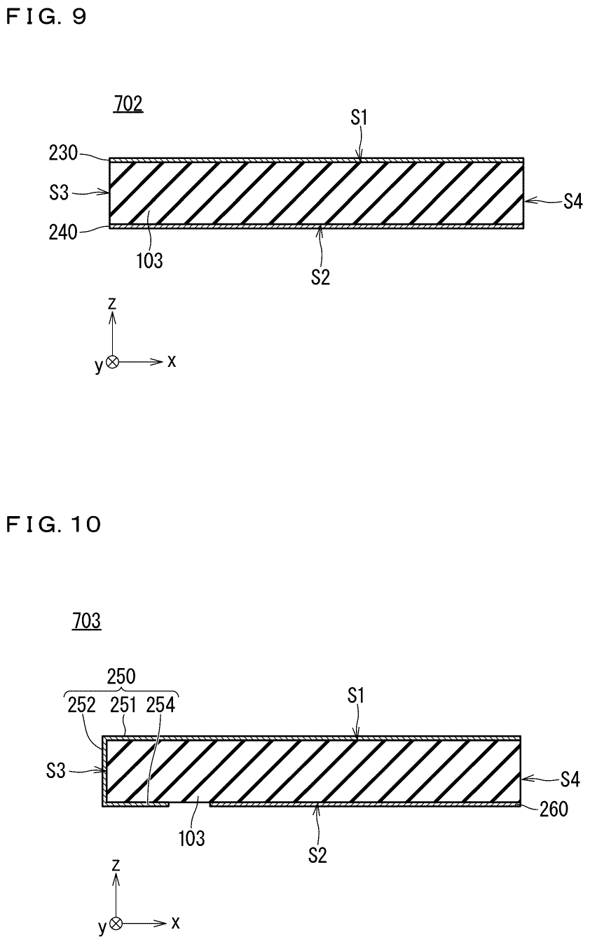

FIG. 10 is a cross-sectional view schematically illustrating a structure of a multilayered ceramic electronic component 703 according to Embodiment 4. The ceramic portion 103 of the multilayered ceramic electronic component 703 may be identical to the ceramic portion 101 (FIG. 3) in Embodiment 1, the ceramic portion 102 (FIG. 7) in Embodiment 2, or one of the ceramic portions of these modifications.

The multilayered ceramic electronic component 703 includes a first electrode 250 and a second electrode 260, in place of the first electrode 210 and the second electrode 220 in the multilayered ceramic electronic component 701 (FIG. 2). The first electrode 250 includes a portion 251 located on the first surface S1. In the present embodiment, the first electrode 250 includes a portion 254 located on the second surface S2 and a portion 252 located on a part of the third surface S3. The portion 251 is substantially disposed on the entirety of the first surface S1 in the illustrated example. The second electrode 260 is disposed on the second surface S2, away from the first electrode 250. The second electrode 260 need not be disposed on a surface except the second surface S2. In the present embodiment, the internal electrode layers 213 and 223 (FIG. 2) are not necessary.

Since the structure except the described structure is almost the same as that according to Embodiment 1 or 2, the same reference numerals are assigned to the same or corresponding elements and the description will not be repeated.

### EXAMPLES

The following indicates measurement results of capacitance on Example 1 as a multilayered ceramic electronic component including the ceramic portion 101 (FIG. 3: Embodiment 1), on Examples 2A to 2C as multilayered ceramic electronic components each including the ceramic portion 102 (FIG. 7: Embodiment 2), and on Comparative Example including the first surface S1 and the second surface S2 that are flat unlike these Examples.

TABLE 1

| | Number of | | |
|---|---|---|---|
| | extreme values | Warpage | Capacitance |
| Comparative Example | 0 | 0 μm | +/−0% |
| Example 1 | 1 | 3 μm | +0.2% |
| Example 2A | 2 | 4 μm | +0.5% |
| Example 2B | 2 | 5 μm | +0.8% |
| Example 2C | 2 | 6 μm | +1.0% |

The capacitance above is indicated as a difference with respect to that of Comparative Example. The capacitance was measured by applying a voltage at a frequency of 1 kHz and with an amplitude of 1 V (0±0.5 V) while applying a pair of probe electrodes of an LCR meter on the first electrode 210 and the second electrode 220 (see FIG. 1) on the first surface S1. The measurement results above showed that the capacitance of each of Examples is higher than that of Comparative Example.

The structures described in Embodiments and the modifications can be appropriately combined or omitted unless any contradiction occurs.

What is claimed is:

1. A multilayered ceramic electronic component having a thickness direction, a width direction vertical to the thickness direction, and a length direction vertical to the thickness direction and the width direction, the multilayered ceramic electronic component comprising:
a ceramic portion having a first surface and a second surface opposed to each other in the thickness direction;
a first electrode including a first portion disposed on the first surface; and
a second electrode including a second portion disposed on the second surface,
wherein each of the first surface and the second surface of the ceramic portion includes:
a width dimension in the width direction;
a length dimension in the length direction, the length dimension being larger than the width dimension and smaller than or equal to 1 mm; and
a surface profile along the length direction, the surface profile including warpage of 2 μm or more in the thickness direction.

2. The multilayered ceramic electronic component according to claim 1,
wherein the ceramic portion has a third surface and a fourth surface opposed to each other in the length direction,
the first electrode includes a third portion disposed on the third surface; and
the second electrode includes a fourth portion disposed on the fourth surface.

3. The multilayered ceramic electronic component according to claim 2,
wherein the first electrode includes a first internal electrode layer disposed in the ceramic portion and connected to the third portion.

4. The multilayered ceramic electronic component according to claim 3,
wherein the second electrode includes a second internal electrode layer disposed in the ceramic portion and connected to the fourth portion.

5. The multilayered ceramic electronic component according to claim 1,
wherein the surface profile includes a plurality of extreme values.

6. The multilayered ceramic electronic component according to claim 5,
wherein at least one of the first surface or the second surface includes a slit region sandwiched between a region covered with the first electrode and a region covered with the second electrode, and
one of the plurality of extreme values of each of the first surface and the second surface exists in the slit region of the first surface or the second surface.

7. The multilayered ceramic electronic component according to claim 5,
wherein the plurality of extreme values are two extreme values of a first extreme value and a second extreme value.

8. The multilayered ceramic electronic component according to claim 7,
wherein the first extreme value and the second extreme value are located in the length direction at a first position and a second position, respectively, and
a distance from a midpoint of the surface profile in the length direction to the second position is longer than a distance from the midpoint to the first position.

9. The multilayered ceramic electronic component according to claim 8,
wherein an absolute value of the second extreme value is smaller than an absolute value of the first extreme value under leveling such that values of both ends of the surface profile are zero.

10. The multilayered ceramic electronic component according to claim 7,
wherein an absolute value of the second extreme value is 0.2 μm or more, and is less than half an absolute value of the first extreme value.
